(19) United States
(12) Patent Application Publication
(10) Pub. No.: US 2025/0376047 A1
(43) Pub. Date: Dec. 11, 2025

(54) CONTROL METHOD, CONTROL DEVICE, ELECTRIC VEHICLE, AND RECORDING MEDIUM

(71) Applicant: Panasonic Intellectual Property Management Co., Ltd., Osaka (JP)

(72) Inventor: Kazuma KITAZAWA, Osaka (JP)

(21) Appl. No.: 19/301,313

(22) Filed: Aug. 15, 2025

Related U.S. Application Data
(63) Continuation of application No. PCT/JP2023/044769, filed on Dec. 14, 2023.

(30) Foreign Application Priority Data
Feb. 28, 2023 (JP) 2023-029535

(51) Int. Cl. B60L 15/30; A61G 5/04; G05D 1/628; G05D 105/22

(52) U.S. Cl. CPC B60L 15/30; G05D 1/628; A61G 5/04; B60L 2200/34; B60L 2240/60; B60L 2250/24; B60L 2260/26; G05D 2105/24

(57) ABSTRACT

A control method, which is to be performed by a computer to control an electric vehicle that includes an operation component, includes: setting a traveling mode of the electric vehicle to a manual mode in which the electric vehicle travels in a direction and at a speed that are based on an operation performed on the operation component by an occupant of the electric vehicle; determining whether a passage having a width that satisfies a predetermined condition is present within a detection range, the detection range being set in a vicinity of the electric vehicle and being based on the operation; and when the passage is determined to be present, switching the traveling mode of the electric vehicle from the manual mode to a passage mode in which the electric vehicle autonomously travels along the passage.

### CROSS REFERENCE TO RELATED APPLICATIONS

This is a continuation application of PCT International Application No. PCT/JP2023/044769 filed on Dec. 14, 2023, designating the United States of America, which is based on and claims priority of Japanese Patent Application No. 2023-029535 filed on Feb. 28, 2023. The entire disclosures of the above-identified applications, including the specifications, drawings and claims are incorporated herein by reference in their entirety.

### FIELD

The present disclosure relates to a technology for controlling traveling of an electric vehicle.

### BACKGROUND

A control method has been proposed that enables control over an electric vehicle to cause the electric vehicle to autonomously enter a narrow passage and travel on the narrow passage (see Patent Literature (PTL) 1, for example). By this control method disclosed in PTL 1, two distance sensors disposed in the electric vehicle are used to detect a distance from a position in the vicinity of the left-side end of the electric vehicle to an obstacle and a distance from a position in the vicinity of the right-side end of the electric vehicle to the obstacle. Then, based on the detected distances, a right or left turn of the electric vehicle is controlled.

### CITATION LIST

### Patent Literature

PTL 1: Japanese Unexamined Patent Application Publication No. 2018-180870

### SUMMARY

### Technical Problem

Unfortunately, the control method disclosed in PTL 1 described above is uncapable of easily causing the electric vehicle to travel along the narrow passage as intended by an occupant of the electric vehicle.

In response to this, the present disclosure provides a control method capable of easily causing an electric vehicle to travel along a narrow passage as intended by an occupant.

### Solution to Problem

A control method according to a first aspect of the present disclosure is to be performed by a computer to control an electric vehicle that includes an operation component, and the control method includes: setting a traveling mode of the electric vehicle to a manual mode in which the electric vehicle travels in a direction and at a speed that are based on an operation performed on the operation component by an occupant of the electric vehicle; determining whether a passage having a width that satisfies a predetermined condition is present within a detection range, the detection range being set in a vicinity of the electric vehicle and being based on the operation; and when the passage is determined to be present, switching the traveling mode of the electric vehicle from the manual mode to a passage mode in which the electric vehicle autonomously travels along the passage.

General or specific aspects of the present disclosure may be implemented to a system, a device, a method, an integrated circuit, a computer program, a computer-readable recording medium such as a Compact Disc-Read Only Memory (CD-ROM), or any given combination thereof. Furthermore, the recording medium may be a non-transitory recording medium.

### Advantageous Effects

The control method according to the present disclosure is capable of easily causing an electric vehicle to travel along a narrow passage as intended by an occupant.

Further advantages and effects according to one aspect of the present disclosure should be obvious from the present specification and the accompanying drawings. Although at least either the advantages or the effects are achieved by the elements described in an embodiment, the present specification, and the accompanying drawings, not all the elements are required.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates an example of a configuration of an electric vehicle according to Embodiment.

FIG. 2A illustrates an example of a detection range according to Embodiment.

FIG. 2B illustrates another example of the detection range according to Embodiment.

FIG. 2C illustrates still another example of the detection range according to Embodiment.

FIG. 2D illustrates still another example of the detection range according to Embodiment.

FIG. 3 illustrates an example of a series of operations of the electric vehicle to travel along a narrow passage according to Embodiment.

FIG. 4 illustrates the example of the series of operations of the electric vehicle to travel along the narrow passage according to Embodiment.

FIG. 5 illustrates the example of the series of operations of the electric vehicle to travel along the narrow passage according to Embodiment.

FIG. 6 illustrates the example of the series of operations of the electric vehicle to travel along the narrow passage according to Embodiment.

FIG. 7 illustrates the example of the series of operations of the electric vehicle to travel along the narrow passage according to Embodiment.

FIG. 8 illustrates the example of the series of operations of the electric vehicle to travel along the narrow passage according to Embodiment.

FIG. 9 illustrates the example of the series of operations of the electric vehicle to travel along the narrow passage according to Embodiment.

FIG. 10 illustrates the example of the series of operations of the electric vehicle to travel along the narrow passage according to Embodiment.

FIG. 11 illustrates the example of the series of operations of the electric vehicle to travel along the narrow passage according to Embodiment.

FIG. 12 illustrates the example of the series of operations of the electric vehicle to travel along the narrow passage according to Embodiment.

FIG. 13 illustrates the example of the series of operations of the electric vehicle to travel along the narrow passage according to Embodiment.

FIG. 14 illustrates another example of a series of operations of the electric vehicle to travel along a narrow passage according to Embodiment.

FIG. 15 illustrates the other example of the series of operations of the electric vehicle to travel along the narrow passage according to Embodiment.

FIG. 16 illustrates the other example of the series of operations of the electric vehicle to travel along the narrow passage according to Embodiment.

FIG. 17 illustrates the other example of the series of operations of the electric vehicle to travel along the narrow passage according to Embodiment.

FIG. 18 is a schematic flowchart illustrating an example of a processing operation performed by a control processor according to Embodiment.

FIG. 19A is a detailed flowchart illustrating an example of the processing operation performed by the control processor according to Embodiment.

FIG. 19B is a detailed flowchart illustrating an example of the processing operation performed by the control processor according to Embodiment.

FIG. 19C is a detailed flowchart illustrating an example of the processing operation performed by the control processor according to Embodiment.

### DESCRIPTION OF EMBODIMENT

### (Underlying Knowledge Forming Basis of the Present Disclosure)

In relation to PTL 1 described in the Background section, the inventors have found the following issue.

By the control method of the electric vehicle as disclosed in PTL 1, the electric vehicle travels autonomously. More specifically, this electric vehicle does not include an operation component, such as a joystick. Note that the operation component receives an operation performed by an occupant and outputs, based on the operation, a signal for controlling the direction of travel and the speed of the electric vehicle. In other words, the electric vehicle disclosed in PTL 1 travels regardless of an intention or will of the occupant. Moreover, the control method of the electric vehicle disclosed in PTL 1 is a method of causing the electric vehicle to enter an elevator with an open door and is uncapable of causing the electric vehicle to travel along a narrow passage.

Incidentally, by a conventional control method of an electric vehicle that includes the operation component described above, the direction of travel and the speed of the electric vehicle are controlled exactly based on an operation performed on the operation component by an occupant of the electric vehicle. Thus, by this control method, it is difficult for an occupant operating this operation component for the first time or an occupant unskilled in operating the operation component to drive the electric vehicle properly along a path with a small width, like a narrow passage.

In order to solve the above problems, a control method according to a first aspect of the present disclosure is to be performed by a computer to control an electric vehicle that includes an operation component, and includes: setting a traveling mode of the electric vehicle to a manual mode in which the electric vehicle travels in a direction and at a speed that are based on an operation performed on the operation component by an occupant of the electric vehicle; determining whether a passage having a width that satisfies a predetermined condition is present within a detection range, the detection range being set in a vicinity of the electric vehicle and being based on the operation; and when the passage is determined to be present, switching the traveling mode of the electric vehicle from the manual mode to a passage mode in which the electric vehicle autonomously travels along the passage. For example, the passage is a narrow passage, and the passage mode is also referred to as a narrow passage mode. Furthermore, one example of the operation component is a joystick.

With this, when the passage is present within the detection range set based on the operation performed by the occupant, the traveling mode of the electric vehicle is switched from the manual mode to the passage mode. Thus, the operation to include the desired passage in the detection range allows the occupant to drive the electric vehicle on the passage without precisely operating the operation component. Furthermore, when a plurality of passages are present in the vicinity of the electric vehicle, the occupant can select the passage that the occupant wants to pass through, using the operation component. Thus, the occupant can easily drive the electric vehicle along the passage as intended.

Furthermore, in the control method according to a second aspect of the present disclosure which depends on the first aspect, it is possible that, in the passage mode, the electric vehicle is set to autonomously travel while the occupant continuously operates the operation component.

With this, although the electric vehicle is autonomously traveling, the occupant is operating the operation component and this makes the occupant feel as if manually driving the electric vehicle. More specifically, the intention of the occupant can be reflected more in the autonomous driving of the electric vehicle.

Furthermore, in the control method according to a third aspect of the present disclosure which depends on the first or second aspect, it is possible that, in the passage mode, the electric vehicle is set to autonomously travel when the direction based on the operation performed on the operation component by the occupant is within a predetermined angular range from a reference direction.

With this, even when a difference between the direction based on the operation performed on the operation component and the reference direction is present within the predetermined angular range, the electric vehicle can be driven along the passage. More specifically, the occupant can drive the electric vehicle along the passage without precisely operating the operation component.

Furthermore, in the control method according to a fourth aspect of the present disclosure which depends on the third aspect, it is possible that the reference direction is one of: a direction of travel of the electric vehicle; a heading direction of the electric vehicle; or a direction along a center line of the passage.

With this, even when the occupant fails to properly zero the angle between the reference direction, such as the heading direction, and the direction based on the operation performed on the operation component, the occupant can drive the electric vehicle along the passage. Thus, regardless of operational skills of the occupant, the electric vehicle can be driven smoothly along the passage.

Furthermore, in the control method according to a fifth aspect of the present disclosure which depends on any one of the first to fourth aspects, it is possible that the control method further includes: in the passage mode, calculating a position of at least one point disposed along the passage; and controlling a direction of travel of the electric vehicle to cause the electric vehicle to pass through the at least one point.

With this, the operation on the operation component by the occupant is performed to inform the computer only about the intention of the occupant to drive the electric vehicle along the passage. More specifically, the operation is not used for precisely controlling the direction of travel of the electric vehicle. Thus, regardless of operational skills of the occupant, the electric vehicle can be driven smoothly along the passage.

Furthermore, in the control method according to a sixth aspect of the present disclosure which depends on any one of the first to fifth aspects, it is possible that the control method further includes: determining whether the passage is outside the detection range; and when the passage is determined to be outside the detection range, switching the traveling mode of the electric vehicle from the passage mode to the manual mode.

With this, when the passage has been determined to be outside the detection range, this means that the electric vehicle is in the vicinity of the exit of the passage. The traveling mode switched to the manual mode at this time allows the occupant to drive the electric vehicle as intended without regard to the passage. Thus, the narrow passage mode is smoothly switched to the manual mode.

Furthermore, in the control method according to a seventh aspect of the present disclosure which depends on any one of the first to sixth aspects, it is possible that, in the passage mode, autonomous driving of the electric vehicle is stopped when the operation performed on the operation component by the occupant is paused, and the autonomous driving of the electric vehicle is resumed when the operation is resumed.

With this, even when the electric vehicle is autonomously traveling, the electric vehicle can be stopped or driven as intended by the occupant.

Hereinafter, a certain exemplary embodiment will be described in detail with reference to the accompanying Drawings.

The following embodiment is a general or specific example of the present disclosure. The numerical values, shapes, materials, elements, arrangement and connection configuration of the elements, steps, the order of the steps, etc., described in the following embodiment are merely examples, and are not intended to limit the present disclosure. Among elements in the following embodiment, those not described in any one of the independent claims indicating the broadest concept of the present disclosure are described as optional elements. Note that the respective figures are schematic diagrams and are not necessarily precise illustrations. Additionally, components that are essentially the same share like reference signs in the figures.

### EMBODIMENT

### [System Configuration]

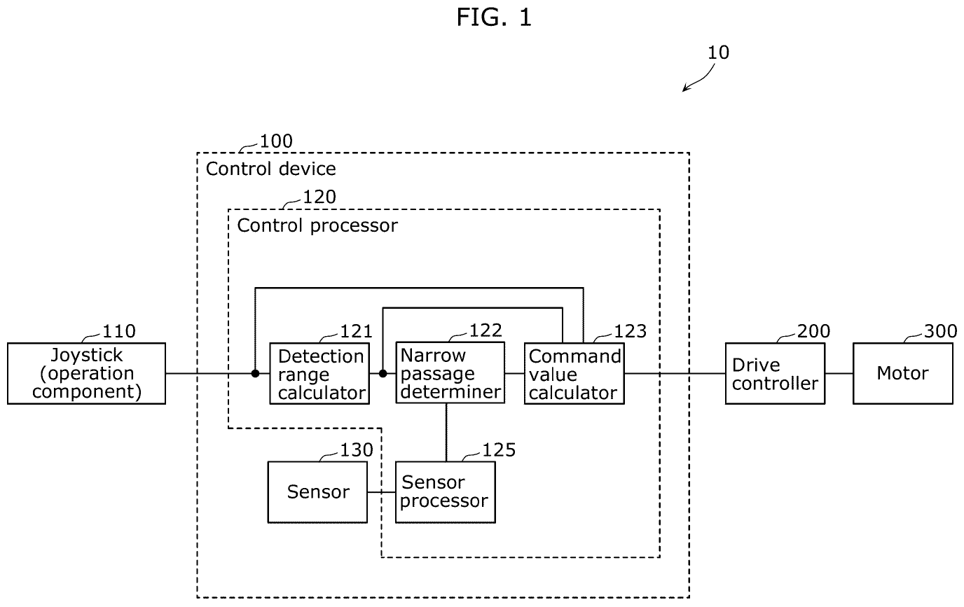

FIG. 1 illustrates an example of a configuration of an electric vehicle according to Embodiment.

Electric vehicle 10 according to the present embodiment is capable of easily traveling along a narrow passage as intended by an occupant of electric vehicle 10. Electric vehicle 10 is an electric wheelchair, for example. A specific example of the narrow passage is a passage for passing through a ticket gate in a train station or a boarding gate in an airport. Such a narrow passage may represent a passage with a small width that does not allow electric vehicle 10 and another person other than the occupant to go on side by side. This width may be 50 cm to 100 cm, for example. Electric vehicle 10 as described includes control device 100, joystick 110, drive controller 200, and motor 300.

Motor 300 generates power for propelling electric vehicle 10. Drive controller 200 drives motor 300 under the control of control device 100.

Joystick 110 receives an operation performed by the occupant of electric vehicle 10, and then outputs an operation signal based on this operation to control device 100. Joystick 110 is also referred to as an operation component or simply as a stick. For example, joystick 110 is mounted on an armrest of electric vehicle 10 to stand upright on a surface of the armrest. Furthermore, when not touched by the occupant, joystick 110 is in a neutral position along a direction perpendicular to the surface of the armrest. In response to an operation performed by the hand of the occupant, joystick 110 is tilted. For example, joystick 110 is tiltable in any direction within a range of 0 degrees to 360 degrees around a base of joystick 110 as electric vehicle 10 is viewed from above. Joystick 110 outputs an operation signal based on the tilted state.

Control device 100 is a computer that obtains the operation signal outputted from joystick 110 and controls drive controller 200 based on the obtained operation signal. More specifically, by controlling drive controller 200, control device 100 controls traveling of electric vehicle 10. Control device 100 includes control processor 120 and sensor 130.

Sensor 130 detects the position of an object present in the vicinity of electric vehicle 10 using, for example, Light Detection And Ranging (LIDAR) technology. Then, sensor 130 outputs a detection signal indicating a result of the detection to control processor 120. To be more specific, this detection signal is outputted to sensor processor 125, described later, that is included in control processor 120. Note that a method of detecting the position of an object is not limited to using LiDAR technology and any method may be used.

Control processor 120 includes detection range calculator 121, narrow passage determiner 122, command value calculator 123, and sensor processor 125.

Sensor processor 125 controls sensor 130. Sensor processor 125 obtains the detection signal outputted from sensor 130 and then outputs this detection signal to narrow passage determiner 122.

Detection range calculator 121 obtains the operation signal outputted from joystick 110. Then, detection range calculator 121 calculates a detection range based on this operation signal and sets this detection range. The detection range refers to a range to detect a narrow passage and is set in the vicinity of electric vehicle 10. Then, detection range calculator 121 outputs a detection range signal indicating the set detection range to narrow passage determiner 122.

Narrow passage determiner 122 obtains the detection range signal outputted from detection range calculator 121 and obtains the detection signal outputted from sensor processor 125. Based on the detection signal, narrow passage determiner 122 determines whether a narrow passage is present in the detection range indicated by the detection range signal. Then, narrow passage determiner 122 outputs a determination result signal indicating the result of this determination to command value calculator 123. Moreover, narrow passage determiner 122 outputs the detection signal obtained from sensor processor 125 to command value calculator 123.

Command value calculator 123 obtains: the operation signal outputted from joystick 110; the detection range signal outputted from detection range calculator 121; and the determination result signal and the detection signal outputted from narrow passage determiner 122. Based on at least the determination result signal, command value calculator 123 switches a traveling mode of electric vehicle 10 between a manual mode and a narrow passage mode. In accordance with the traveling mode, command value calculator 123 calculates a command value for commanding traveling of electric vehicle 10. Then, by controlling drive controller 200 based on the command value, command value calculator 123 causes electric vehicle 10 to travel. In the manual mode, electric vehicle 10 travels in a direction and at a speed based on an operation performed on joystick 110 by the occupant of electric vehicle 10. In the narrow passage mode, electric vehicle 10 autonomously travels along the narrow passage in accordance with the intention or will of the occupant. To be more specific, electric vehicle 10 avoids bumping into a wall of the narrow passage while autonomously traveling on the narrow passage. Note that autonomous driving referred to in the present embodiment is, so to speak, semi-autonomous driving because the intention or will of the occupant is reflected in the traveling.

### [Detection Range]

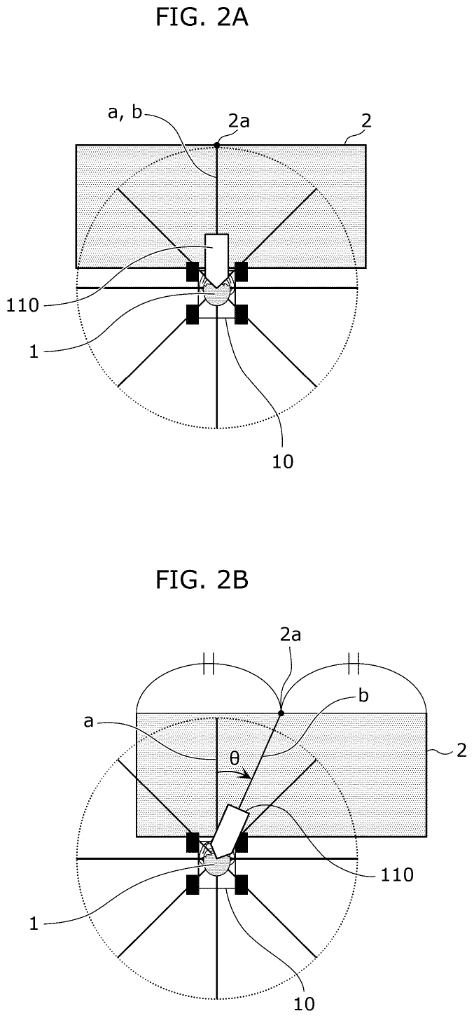

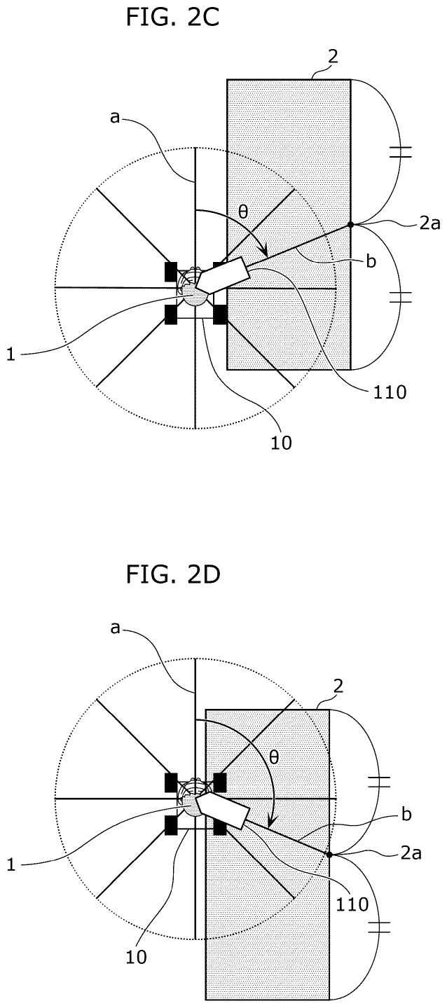

FIG. 2A to FIG. 2D illustrate examples of the detection range. Note that FIG. 2A to FIG. 2D illustrate electric vehicle 10 viewed from above and also illustrate joystick 110 enlarged for simplicity to make the direction in which joystick 110 is tilted easy to see.

As illustrated in FIG. 2A, occupant 1 tilts joystick 110 in heading direction a of electric vehicle 10, for example. Note that heading direction a refers to a direction from a center of electric vehicle 10 to a front end of electric vehicle 10. In this case, heading direction a and direction b in which joystick 110 is tilted are in the same direction. Thus, detection range calculator 121 sets detection range 2 directly in front of electric vehicle 10. Detection range 2 is, for example, a rectangular range that has two short sides parallel to heading direction a and two long sides perpendicular to heading direction a. Midpoint 2a of the long side that is farther from electric vehicle 10 out of the two long sides is set on a line extending from electric vehicle 10 in heading direction a.

As illustrated in FIG. 2B, occupant 1 tilts joystick 110 in direction b that is tilted clockwise at angle θ from heading direction a of electric vehicle 10. Angle θ is less than or equal to 45 degrees. In this case, detection range calculator 121 sets detection range 2 at a position shifted to the right from the direct front of electric vehicle 10. As with the above, detection range 2 is a rectangular range, for example. Midpoint 2a of the long side that is farther from electric vehicle 10 out of the two long sides of detection range 2 is set on a line extending from electric vehicle 10 in direction b.

As illustrated in FIG. 2C, occupant 1 tilts joystick 110 in direction b that is tilted clockwise at angle θ from heading direction a of electric vehicle 10. Angle θ is greater than 45 degrees and less than or equal to 90 degrees. In this case, detection range calculator 121 sets detection range 2 at a position shifted forward on the right side of electric vehicle 10. As with the above, detection range 2 is, for example, a rectangular range that has two long sides parallel to heading direction a and two short sides perpendicular to heading direction a. More specifically, detection range 2 illustrated in FIG. 2C is rotated 90 degrees clockwise with respect to detection ranges 2 illustrated in FIG. 2A and FIG. 2B. Midpoint 2a of the long side that is farther from electric vehicle 10 out of the two long sides of detection range 2 is set on a line extending from electric vehicle 10 in direction b.

As illustrated in FIG. 2D, occupant 1 tilts joystick 110 in direction b that is tilted clockwise at angle θ from heading direction a of electric vehicle 10. Angle θ is greater than 90 degrees and less than or equal to 135 degrees. In this case, detection range calculator 121 sets detection range 2 at a position shifted backward on the right side of electric vehicle 10. As with the above, detection range 2 is, for example, a rectangular range that has two long sides parallel to heading direction a and two short sides perpendicular to heading direction a. More specifically, detection range 2 illustrated in FIG. 2D is shifted backward with respect to detection range 2 illustrated in FIG. 2C. Midpoint 2a of the long side that is farther from electric vehicle 10 out of the two long sides of detection range 2 is set on a line extending from electric vehicle 10 in direction b.

As illustrated in FIG. 2A to FIG. 2D, detection range 2 is set in direction b in which joystick 110 is tilted. Note that when joystick 110 is in the neutral position instead of being tilted, detection range 2 is not set. Furthermore, as illustrated in FIG. 2A to FIG. 2D, the orientation of detection range 2 is different by 90 degrees between when angle θ is less than or equal to 45 degrees and when angle θ is greater than 45 degrees. More specifically, for angle θ greater than −45 degrees and less than or equal to 45 degrees, detection range 2 that has the long sides perpendicular to heading direction a is set. Similarly, for angle θ greater than 135 degrees or angle θ less than or equal to −135 degrees, detection range 2 that has the long sides perpendicular to heading direction a is set. In contrast, for angle θ greater than 45 degrees and less than or equal to 135 degrees, detection range 2 that has the long sides parallel to heading direction a is set. Similarly, for angle θ greater than −135 degrees and less than or equal to −45 degrees, detection range 2 that has the long sides parallel to heading direction a is set.

Furthermore, detection range calculator 121 may change the size of detection range 2, based on a tilt angle at which joystick 110 is tilted. Note that the tilt angle refers to a measure of an angle at which joystick 110 is tilted and thus is an angle between a direction perpendicular to the surface of the armrest of electric vehicle 10 and a direction along the longitudinal direction of joystick 110. Detection range calculator 121 increases the size of detection range 2 as the tilt angle increases. More specifically, as the tilt angle increases, detection range calculator 121 increases the size of detection range 2 by making midpoint 2a of detection range 2 farther away from electric vehicle 10.

### [Example 1 of Narrow Passage Traveling]

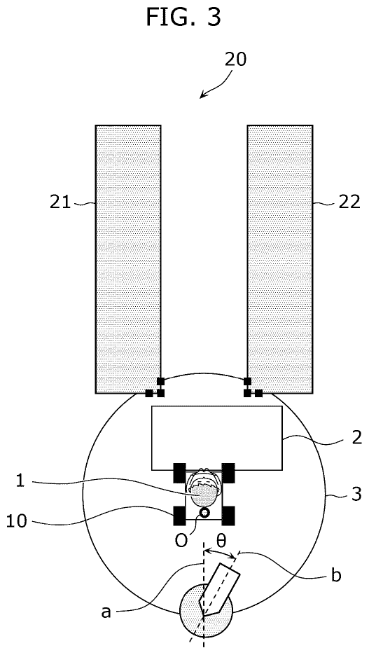

FIG. 3 to FIG. 13 illustrate an example of a series of operations performed when electric vehicle 10 travels on a narrow passage. Note that FIG. 3 to FIG. 13 illustrate electric vehicle 10 viewed from above and also illustrate joystick 110 enlarged for simplicity to make the direction in which joystick 110 is tilted easy to see.

As illustrated in FIG. 3, electric vehicle 10 travels in the manual mode in the vicinity of narrow passage 20 between walls 21 and 22. In the manual mode, electric vehicle 10 travels along a direction in which joystick 110 is tilted (that is, direction b) and at a speed based on the tilt angle at which joystick 110 is tilted. As the tilt angle increases, the traveling speed of electric vehicle 10 increases. To be more specific, by controlling drive controller 200, command value calculator 123 causes electric vehicle 10 to travel in the direction and at the speed based on the operation signals outputted from joystick 110. Note that point O illustrated in FIG. 3 is a rotation center of electric vehicle 10.

Sensor 130 detects a position of an object present in measurement range 3. Measurement range 3 is a circular range centered at electric vehicle 10 with a predetermined radius, for example. Detection range calculator 121 sets detection range 2 within measurement range 3. Note that FIG. 3 to FIG. 13 illustrate examples where direction b of joystick 110 is tilted clockwise at angle θ from heading direction a. Angle θ is greater than 0 degrees and less than or equal to 45 degrees. Thus, when viewed from electric vehicle 10, detection range 2 is set at a position shifted slightly to the right in front of electric vehicle 10.

In the example illustrated in FIG. 3, ends of walls 21 and 22 of narrow passage 20 that are on the electric vehicle 10 side are within measurement range 3. Thus, sensor 130 detects positions of these ends and outputs detection signals indicating a result of the detection.

Note that each black spot on surfaces of walls 21 and 22 in the examples illustrated in FIG. 3 to FIG. 13 indicates a position of an object detected by sensor 130. However, walls 21 and 22 are not within detection range 2. On this account, narrow passage determiner 122 determines that narrow passage 20 is not present in detection range 2 and outputs a determination result signal indicating the absence of narrow passage 20.

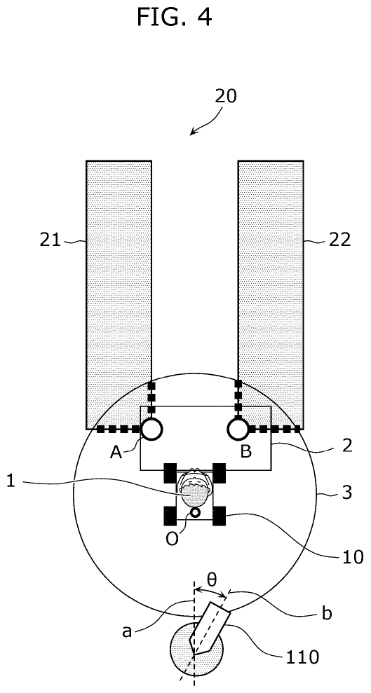

Next, electric vehicle 10 approaches walls 21 and 22 of narrow passage 20, as illustrated in FIG. 4. At this time, the ends of walls 21 and 22 of narrow passage 20 that are on the electric vehicle 10 side enter detection range 2. Thus, narrow passage determiner 122 determines that narrow passage 20 is present in detection range 2 and outputs a determination result signal indicating the result of the determination to command value calculator 123. Command value calculator 123 receives this determination result signal and calculates, based on the positions of walls 21 and 22 indicated by the detection signals (that is, a plurality of black spots in FIG. 4), a position of point A on wall 21 and a position of point B on wall 22. Point A denotes an inside corner of wall 21 of narrow passage 20 whereas point B denotes an inside corner of wall 22 of narrow passage 20.

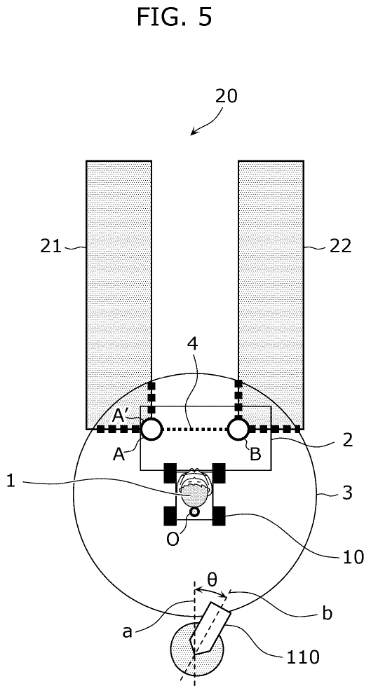

Next, command value calculator 123 draws perpendicular line 4 from point B to an inner surface of wall 21, as illustrated in FIG. 5. More specifically, command value calculator 123 sets a perpendicular line passing through point B and perpendicular to the inner surface of wall 21, as perpendicular line 4. Moreover, command value calculator 123 sets a point where perpendicular line 4 intersects with the inner surface of wall 21, as point A′. Note that, in the example illustrated in FIG. 5, because points A and B are in the same position in the direction of narrow passage 20 (or more specifically, in the vertical direction of FIG. 5), perpendicular line 4 may be drawn from point A to an inner surface of wall 22. In this case, a point where perpendicular line 4 intersects with the inner surface of wall 22 is set as point B′. Furthermore, command value calculator 123 determines whether a length of line segment BA′ is greater than a sum of width w and extra width α1 of electric vehicle 10. To be more specific, whether a passing condition “(length of line segment BA′)>w+α1” is satisfied is determined. Note that extra width α1 is any numeric value greater than 0. When command value calculator 123 has determined that the passing condition is satisfied, command value calculator 123 switches the traveling mode of electric vehicle 10 from the manual mode to the narrow passage mode.

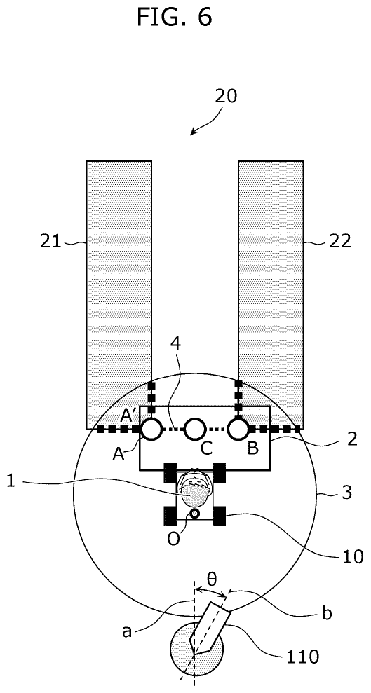

Next, command value calculator 123 calculates point C that is a midpoint of line segment BA′, as illustrated in FIG. 6. In other words, command value calculator 123 sets point C.

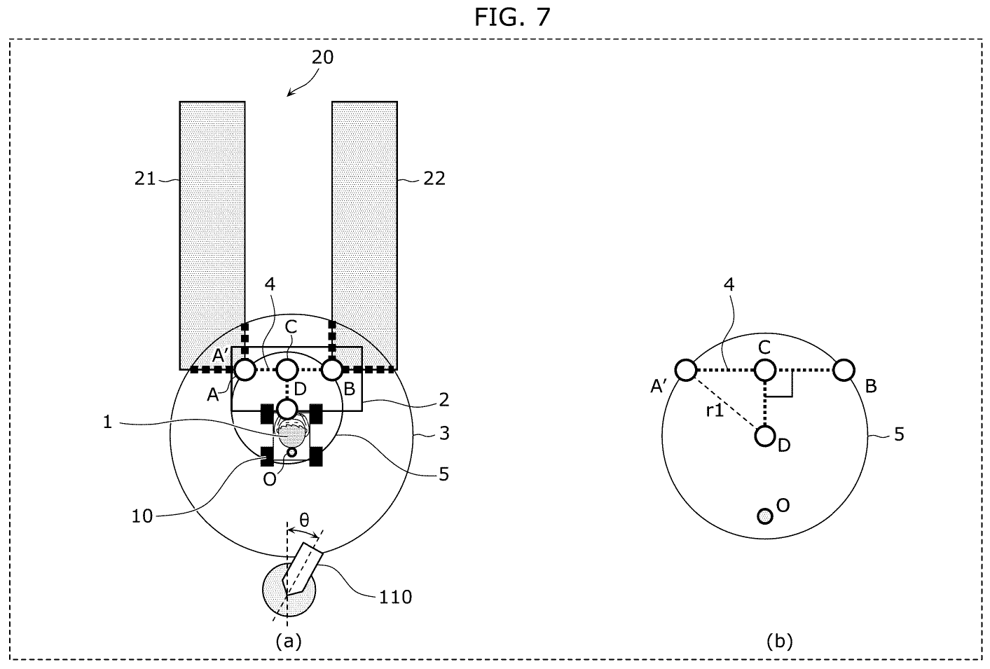

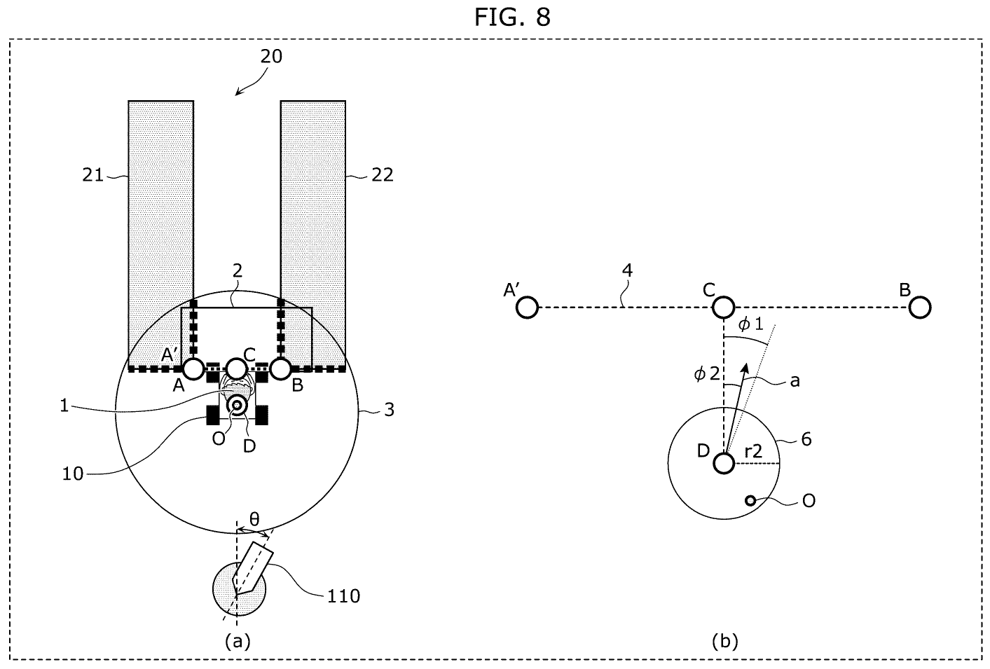

Next, command value calculator 123 calculates point D that passes through point C and is on a line perpendicular to line segment BA′, as illustrated in (a) and (b) of FIG. 7. In other words, command value calculator 123 sets point D. Note that (b) of FIG. 7 illustrates an enlarged view of arrangement of points A′, B, C, D and O, out of arrangement of electric vehicle 10 and narrow passage 20 illustrated in (a) of FIG. 7. Here, point D is a center of circumference 5 passing through point A′. Radius r1 of circumference 5 is greater than a sum of turning radius r and extra length α2 of electric vehicle 10. Note that extra length α2 is any numeric value greater than 0. To make a turn, electric vehicle 10 turns around point O with turning radius r. In the example illustrated in FIG. 7, circumference 5 passes through not only point A′ but also points A and B. However, circumference 5 may pass through a point, among points A, A′, and B, that is the closest to point D.

Next, for electric vehicle 10 to travel, command value calculator 123 makes point O coincide with point D and also makes heading direction a of electric vehicle 10 align with the direction of narrow passage 20, as illustrated in (a) and (b) of FIG. 8. To be more specific, for electric vehicle 10 to travel, command value calculator 123 sets a state of electric vehicle 10 in an initial traveling state for narrow passage 20. Note that (b) of FIG. 8 illustrates an enlarged view of arrangement of points A′, B, C, D and O, out of arrangement of electric vehicle 10 and narrow passage 20 illustrated in (a) of FIG. 8.

More specifically, to set electric vehicle 10 in the initial traveling state, command value calculator 123 determines whether point O has reached point D. Here, command value calculator 123 may determine that point O has reached point D when point O has entered reach determination range 6 that is circular, as illustrated in (b) of FIG. 8. Reach determination range 6 is a circular range centered at point D with radius r2. When command value calculator 123 has determined that point O has not reached point D, command value calculator 123 causes electric vehicle 10 to continue to travel. Furthermore, to set electric vehicle 10 in the initial traveling state, command value calculator 123 determines whether heading direction a of electric vehicle 10 is aligning with the direction of narrow passage 20. Here, command value calculator 123 may determine that heading direction a of electric vehicle 10 is aligning with the direction of narrow passage 20 when angle φ2 between a direction of line segment CD and heading direction a is less than or equal to allowable angle φ1, as illustrated in (b) of FIG. 8. When command value calculator 123 has determined that heading direction a of electric vehicle 10 is not aligning with the direction of narrow passage 20, command value calculator 123 causes electric vehicle 10 to continue to travel.

When electric vehicle 10 is in the initial traveling state, each of points A, A′, and B is at a distance of radius r1 of circumference 5 described above from rotation center O of electric vehicle 10. Thus, electric vehicle 10 in the initial traveling state can travel to turn in a direction different from the direction of narrow passage 20. For example, when occupant 1 tilts joystick 110 not to include walls 21 and 22 of narrow passage 20 within detection range 2, electric vehicle 10 can move away from narrow passage 20 instead of entering narrow passage 20.

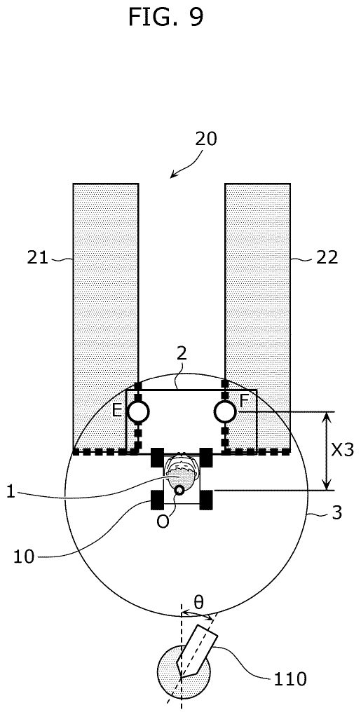

Next, when electric vehicle 10 is in the initial traveling state and walls 21 and 22 of narrow passage 20 are within detection range 2, command value calculator 123 calculates points E and F that are at distance X3 from point O in the direction of narrow passage 20, as illustrated in FIG. 9. In other words, command value calculator 123 sets points E and F. Point E is set on the inner surface of wall 21 of narrow passage 20 whereas point F is set on the inner surface of wall 22 of narrow passage 20. Note that distance X3 is any distance longer than 0.

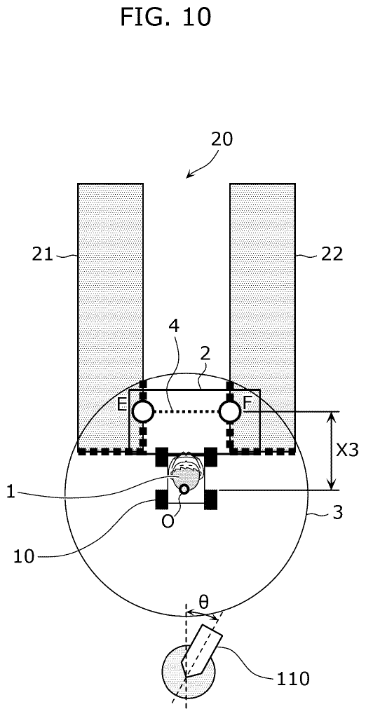

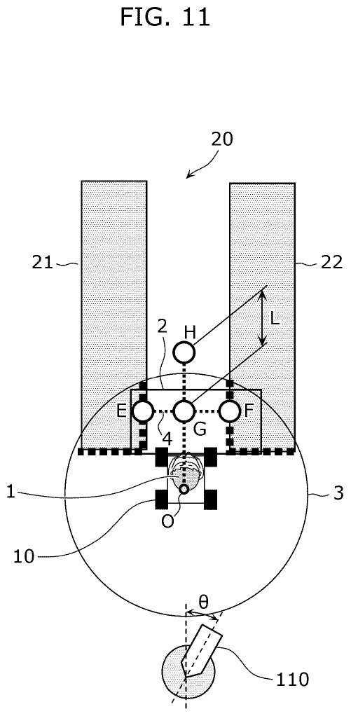

Next, command value calculator 123 determines whether a length of line segment EF is greater than the sum of width w and extra width α1 of electric vehicle 10, as illustrated in FIG. 10. To be more specific, whether a passing condition “(length of line segment EF)>w+α1” is satisfied is determined.

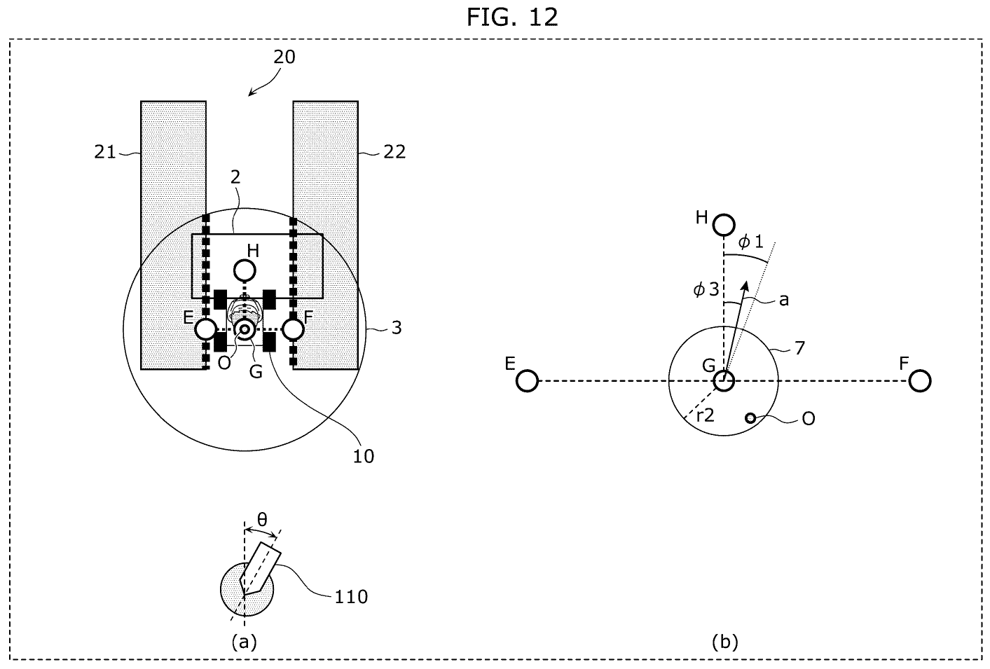

When command value calculator 123 has determined that the passing condition is satisfied, command value calculator 123 calculates point G that is a midpoint of line segment EF and point H that passes through point G and is on a line perpendicular to line segment EF, as illustrated in FIG. 11. Point H is at distance L from point G on the opposite side of electric vehicle 10. Note that distance L is any distance longer than 0.

Next, for electric vehicle 10 to travel, command value calculator 123 makes point O coincide with point G and also makes heading direction a of electric vehicle 10 align with the direction of narrow passage 20, as illustrated in (a) and (b) of FIG. 12. To be more specific, for electric vehicle 10 to travel, command value calculator 123 sets a state of electric vehicle 10 in a target traveling state. Note that (b) of FIG. 12 illustrates an enlarged view of arrangement of points E, F, G, H and O, out of arrangement of electric vehicle 10 and narrow passage 20 illustrated in (a) of FIG. 12.

More specifically, to set electric vehicle 10 in the target traveling state, command value calculator 123 determines whether point O has reached point G. Here, command value calculator 123 may determine that point O has reached point G when point O has entered reach determination range 7 that is circular, as illustrated in (b) of FIG. 12. Reach determination range 7 is a circular range centered at point G with radius r2. When command value calculator 123 has determined that point O has not reached point G, command value calculator 123 causes electric vehicle 10 to continue to travel. Furthermore, to set electric vehicle 10 in the target traveling state, command value calculator 123 determines whether heading direction a of electric vehicle 10 is aligning with the direction of narrow passage 20. Here, command value calculator 123 may determine that heading direction a of electric vehicle 10 is aligning with the direction of narrow passage 20 when angle φ3 between a direction of line segment GH and heading direction a is less than or equal to allowable angle 1, as illustrated in (b) of FIG. 12. When command value calculator 123 has determined that heading direction a of electric vehicle 10 is not aligning with the direction of narrow passage 20, command value calculator 123 causes electric vehicle 10 to continue to travel.

Then, command value calculator 123 causes electric vehicle 10 to continue to travel along narrow passage 20 by repeating the processes illustrated in FIG. 9 to FIG. 12, or more specifically, by repeating the calculations of points E, F, G, and H to set electric vehicle 10 in the target traveling state. In other words, command value calculator 123 causes electric vehicle 10 to travel while points E and F are present in detection range 2 set through an operation performed on joystick 110.

For the autonomous driving in the present embodiment, when narrow passage 20 is present in detection range 2 set through an operation performed on joystick 110, electric vehicle 10 travels to pass through points D and G. Furthermore, for the autonomous driving in the present embodiment, when no operation is performed on joystick 110, detection range 2 is not set and thus electric vehicle 10 stops. Furthermore, for the autonomous driving in the present embodiment, a traveling speed of electric vehicle 10 may be controlled based on a tilt angle of joystick 110. On this account, the autonomous driving in the present embodiment is, so to speak, semi-autonomous driving.

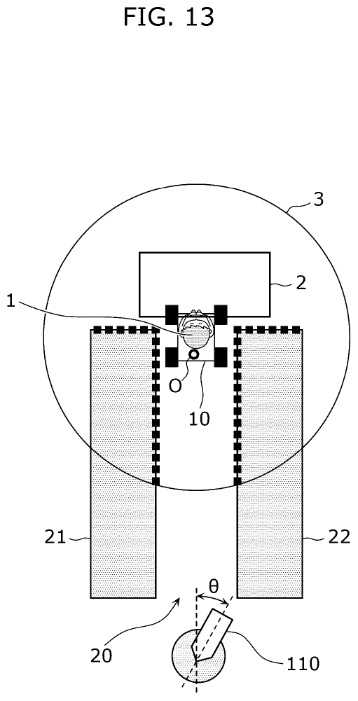

Next, when points E and F cannot be calculated as illustrated in FIG. 13, command value calculator 123 switches the traveling mode of electric vehicle 10 from the narrow passage mode to the manual mode. More specifically, when narrow passage 20 is not present in detection range 2, command value calculator 123 determines that electric vehicle 10 has approached an exit of narrow passage 20 and then has passed through narrow passage 20. Thus, command value calculator 123 switches the traveling mode to the manual mode.

### [Example 2 of Narrow Passage Traveling]

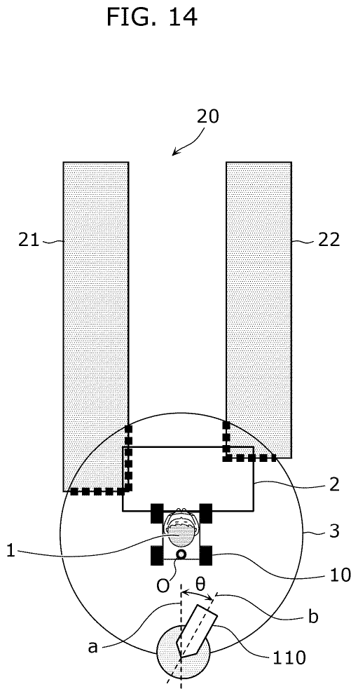

FIG. 14 to FIG. 17 illustrate another example of a series of operations performed when electric vehicle 10 travels on a narrow passage. Note that, as with FIG. 3 to FIG. 13 above, FIG. 14 to FIG. 17 illustrate electric vehicle 10 viewed from above and also illustrate joystick 110 enlarged for simplicity to make the direction in which joystick 110 is tilted easy to see. Furthermore, positions of walls 21 and 22 of narrow passage 20 in FIG. 14 to FIG. 17 are different in the direction of narrow passage 20. To be more specific, wall 21 is longer than wall 22 and the end of wall 21 is lower than the end of wall 22 as viewed in FIG. 14 to FIG. 17.

As illustrated in FIG. 14, electric vehicle 10 travels in the manual mode in the vicinity of narrow passage 20 between walls 21 and 22. Sensor 130 detects a position of an object present in measurement range 3. Detection range calculator 121 sets detection range 2 within measurement range 3. Note that FIG. 14 to FIG. 17 also illustrate examples where direction b of joystick 110 is tilted clockwise at angle θ from heading direction a, as in the examples illustrated in FIG. 3 and FIG. 13. Angle θ is greater than 0 degrees and less than or equal to 45 degrees. Thus, when viewed from electric vehicle 10, detection range 2 is set at a position shifted slightly to the right in front of electric vehicle 10.

In the example illustrated in FIG. 14, the ends of walls 21 and 22 of narrow passage 20 that are on the electric vehicle 10 side are within measurement range 3. Thus, sensor 130 detects positions of these ends and outputs detection signals indicating a result of the detection. Note that each black spot on the surfaces of walls 21 and 22 in the examples illustrated in FIG. 14 to FIG. 17 also indicates a position of an object detected by sensor 130, as in the examples illustrated in FIG. 3 to FIG. 13. Here, the ends of walls 21 and 22 are also within detection range 2. Thus, narrow passage determiner 122 determines that narrow passage 20 is present in detection range 2 and outputs a determination result signal indicating the result of this determination.

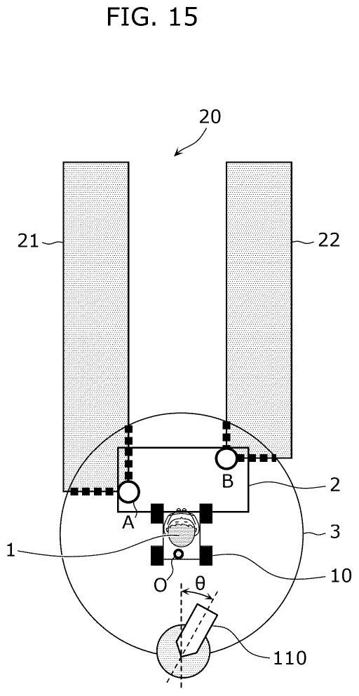

Command value calculator 123 receives this determination result signal and calculates, based on the positions of walls 21 and 22 indicated by the detection signals (that is, a plurality of black spots in FIG. 15), a position of point A on wall 21 and a position of point B on wall 22. Point A denotes an inside corner of wall 21 of narrow passage 20 whereas point B denotes an inside corner of wall 22 of narrow passage 20.

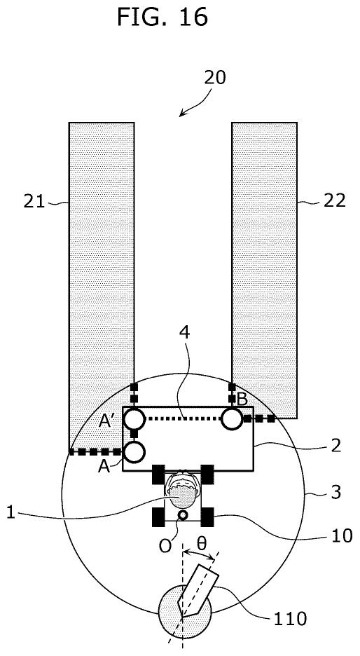

Next, command value calculator 123 draws perpendicular line 4 from point B to the inner surface of wall 21, as illustrated in FIG. 16. More specifically, command value calculator 123 sets a perpendicular line passing through point B and perpendicular to the inner surface of wall 21, as perpendicular line 4. Moreover, command value calculator 123 sets a point where perpendicular line 4 intersects with the inner surface of wall 21, as point A′. Note that, in the example illustrated in FIG. 16, perpendicular line 4 cannot be drawn from point A to the inner surface of wall 22. For this reason, command value calculator 123 draws perpendicular line 4 from point B to the inner surface of wall 21. In this way, command value calculator 123 draws the perpendicular line from a point, out of points A and B, from which the perpendicular line can be drawn, to the inner surface of the wall different from the wall that has this point. Furthermore, command value calculator 123 determines whether a length of line segment BA′ is greater than a sum of width w and extra width α1 of electric vehicle 10. To be more specific, whether the passing condition “(length of line segment BA′)>w+α1” is satisfied is determined. When command value calculator 123 has determined that the passing condition is satisfied, command value calculator 123 switches the traveling mode of electric vehicle 10 from the manual mode to the narrow passage mode.

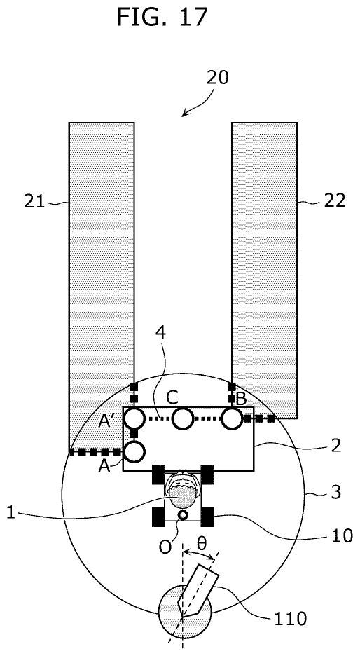

Next, command value calculator 123 calculates point C that is a midpoint of line segment BA′, as illustrated in FIG. 17. In other words, command value calculator 123 sets point C. Then, control device 100 performs the same processing operation as in the examples illustrated in FIG. 7 to FIG. 13. As a result, electric vehicle 10 enters narrow passage 20, travels along narrow passage 20, and passes through narrow passage 20.

According to the present embodiment as illustrated in FIG. 3 to FIG. 17, even when direction b of joystick 110 tilted by occupant 1 is tilted at angle θ from heading direction a and the direction of narrow passage 20, electric vehicle 10 travels along narrow passage 20 in the narrow passage mode while narrow passage 20 is present within detection range 2. More specifically, without having to tilt joystick 110 accurately in the direction of narrow passage 20, occupant 1 can drive electric vehicle 10 appropriately along narrow passage 20 while narrow passage 20 is within detection range 2 set through a tilting operation performed on joystick 110. Thus, by performing an operation on joystick 110 with the intention or will of occupant 1, occupant 1 can appropriately drive electric vehicle 10 along narrow passage 20. For example, when there are a plurality of narrow passages 20, occupant 1 can select a desired narrow passage 20 by changing the position of detection range 2. Furthermore, when electric vehicle 10 is traveling in the narrow passage mode, or more specifically, autonomously traveling, along the desired narrow passage 20, occupant 1 can stop electric vehicle 10 with the will of the user.

### [Process Flow]

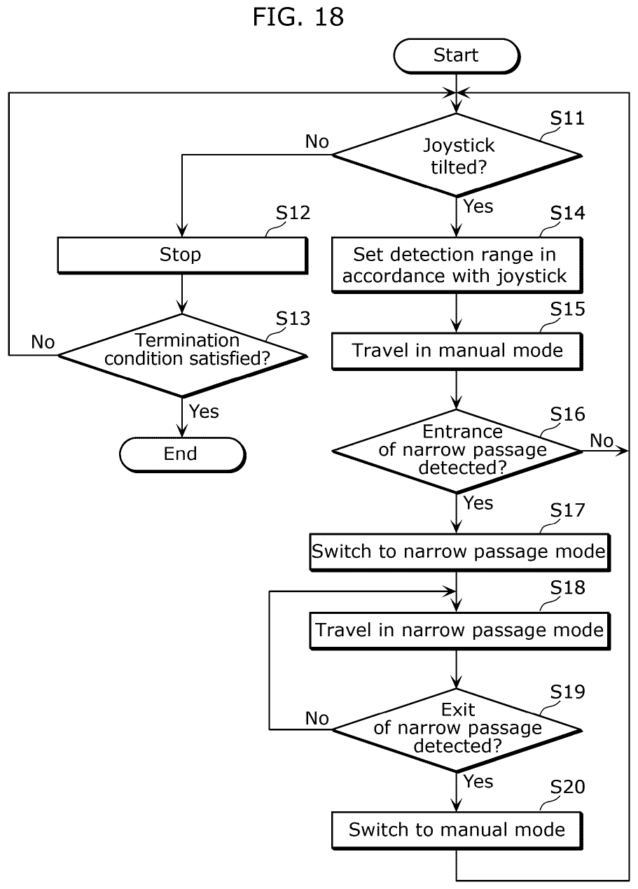

FIG. 18 is a schematic flowchart illustrating an example of the processing operation performed by control processor 120 according to the present embodiment.

Detection range calculator 121 and command value calculator 123 of control processor 120 first determine whether joystick 110 is tilted (Step S11). When command value calculator 123 has determined that joystick 110 is not tilted (No in Step S11), command value calculator 123 stops electric vehicle 10 (Step S12) and determines whether a termination condition is satisfied (Step S13). The termination condition may be a condition that a power switch of electric vehicle 10 is turned off. Then, when command value calculator 123 has determined that the termination condition is satisfied (Yes in Step S13), control processor 120 terminates the entire processing. In contrast, when command value calculator 123 has determined that the termination condition is not satisfied (No in Step S13), control processor 120 repeats the processes from Step S11.

When joystick 110 has been determined to be tilted in Step S11 (Yes in Step S11), detection range calculator 121 sets detection range 2 based on this tilted state of joystick 110, or more specifically, based on the operation signal outputted from joystick 110 (Step S14). Then, in response to the operation signal, command value calculator 123 causes electric vehicle 10 to travel in the manual mode (Step S15). Furthermore, based on detection range 2 set in Step S14 and the detection signal outputted from sensor 130 via sensor processor 125, narrow passage determiner 122 determines whether an entrance of narrow passage 20 is present within detection range 2 (Step S16).

When the entrance of narrow passage 20 has been determined not to be present (No in Step S16), control processor 120 repeats the processes from Step S11. In contrast, when the entrance of narrow passage 20 has been determined to be present, or more specifically, when the entrance of narrow passage 20 has been detected (Yes in Step S16), command value calculator 123 switches the traveling mode of electric vehicle 10 from the manual mode to the narrow passage mode (Step S17).

Then, command value calculator 123 causes electric vehicle 10 to travel in the narrow passage mode (Step S18). Furthermore, command value calculator 123 determines whether the exit of narrow passage 20 is present within detection range 2 (Step S19). When command value calculator 123 has determined that the exit is not present (No in Step S19), command value calculator 123 repeats the processes from Step S18 to cause electric vehicle 10 to continue to travel in the narrow passage mode. In contrast, when command value calculator 123 has determined that the exit is present (Yes in Step S19), command value calculator 123 switches the traveling mode of electric vehicle 10 from the narrow passage mode to the manual mode (Step S20).

Note that regardless of whether the traveling mode is the manual mode or the narrow passage mode, command value calculator 123 causes electric vehicle 10 to stop when joystick 110 is not tilted, and causes electric vehicle 10 to continue to travel when joystick 110 is tilted.

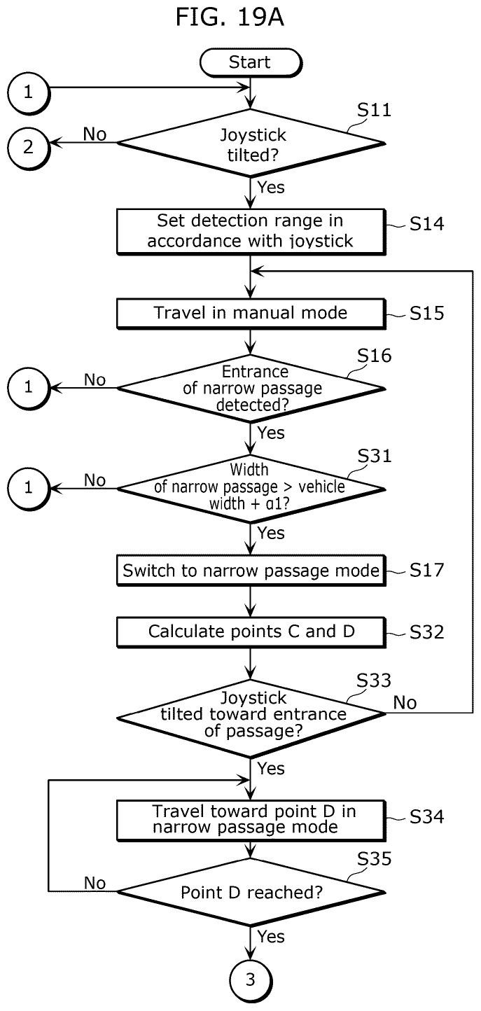

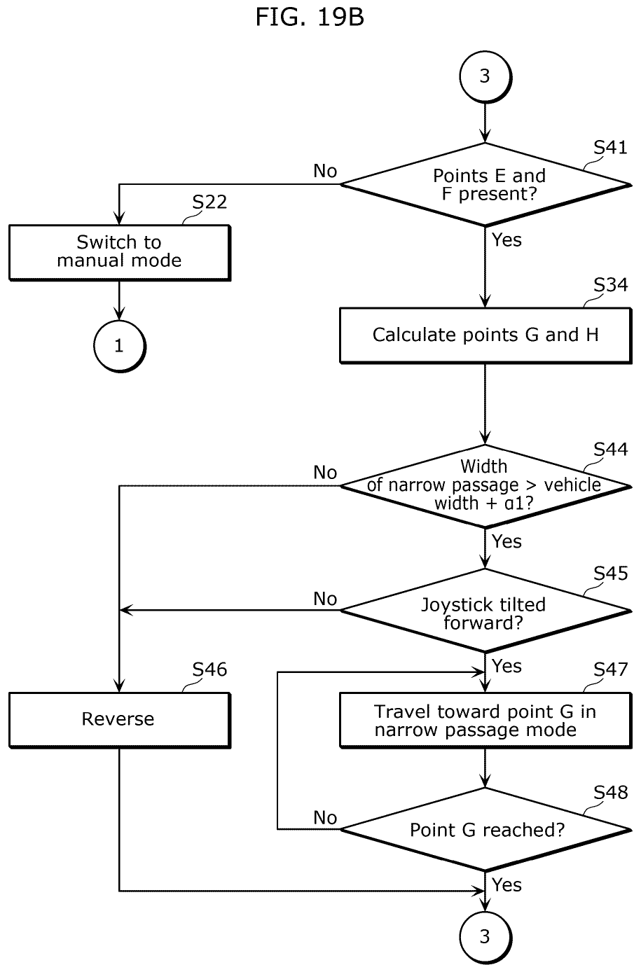

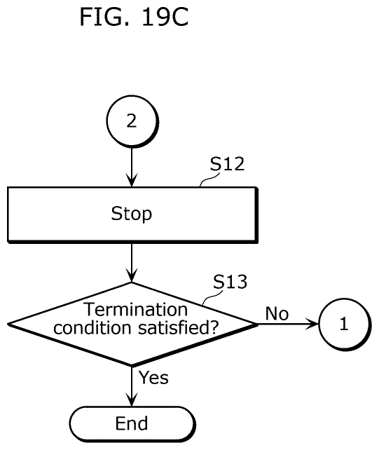

FIG. 19A to FIG. 19C are detailed flowcharts illustrating examples of the processing operation performed by control processor 120 according to the present embodiment.

Control processor 120 first performs processes Steps S11 to S16 as illustrated in FIG. 19A to FIG. 19C, as in the flowchart illustrated in FIG. 18. Then, as illustrated in FIG. 19A, when the entrance of narrow passage 20 has been detected in Step S16 (Yes in Step S16), command value calculator 123 determines whether the passing condition concerning the width of the narrow passage is satisfied (Step S31). The width of the narrow passage is the length of line segment BA′ illustrated in FIG. 5. To be more specific, command value calculator 123 determines whether the passing condition “(length of line segment BA′)>w+α1” is satisfied. Note that w represents the width of electric vehicle 10, and this width is also called the vehicle width.

When the passing condition has been determined not to be satisfied (No in Step S31), control processor 120 repeats the processes from Step S11. In contrast, when the passing condition has been determined to be satisfied (Yes in Step S31), command value calculator 123 switches the traveling of electric vehicle 10 from the manual mode to the narrow passage mode (Step S17). Then, command value calculator 123 calculates points C and D as illustrated in FIG. 6 and FIG. 7 (Step S32). Following this, command value calculator 123 determines whether joystick 110 is tilted toward the entrance of narrow passage 20 and points A, A′, and B are thereby present within detection range 2 (Step S33). When command value calculator 123 has determined that joystick 110 is not tilted toward the entrance of narrow passage 20 (No in Step S33), or more specifically, when points A, A′, and B are not present within detection range 2, command value calculator 123 switches the traveling of electric vehicle 10 from the narrow passage mode to the manual mode and repeats the processes from Step S15. More specifically, at this time, by tilting joystick 110 in a direction different from the direction of the entrance of narrow passage 20, occupant 1 declines to drive on narrow passage 20 and selects driving on a different passage in the manual mode.

In contrast, when command value calculator 123 has determined that joystick 110 is tilted toward the entrance of narrow passage 20 (Yes in Step S33), or more specifically, when points A, A′, and B are present within detection range 2, command value calculator 123 causes electric vehicle 10 to travel to lead point O, which is the rotation center of electric vehicle 10, toward point D (Step S34). Furthermore, command value calculator 123 determines whether point O has reached point D (Step S35). When command value calculator 123 has determined that point O has not reached point D (No in Step S35), command value calculator 123 repeats the processes from Step S34. In contrast, when command value calculator 123 has determined that point O has reached point D (Yes in Step S35), command value calculator 123 executes Step S41 illustrated in FIG. 19B.

In Step S41 as illustrated in FIG. 19B, command value calculator 123 determines whether points E and F are settable (Step S41). When command value calculator 123 has determined that points E and F are not settable (No in Step S41), command value calculator 123 switches the traveling mode of electric vehicle 10 from the narrow passage mode to the manual mode (Step S22). To be more specific, when points E and F are not settable, this indicates that electric vehicle 10 is in the vicinity of the exit of narrow passage 20. Thus, the traveling mode is switched to the manual mode. More specifically, the process in Step S41 corresponds to the process in Step S19 illustrated in FIG. 18.

In contrast, when command value calculator 123 has determined that points E and F are settable (Yes in Step S41), command value calculator 123 calculates points G and H based on points E and F (Step S43). Then, command value calculator 123 determines whether the passing condition concerning the width of the narrow passage is satisfied (Step S44). The width of the narrow passage is the length of line segment EF illustrated in FIG. 10. To be more specific, command value calculator 123 determines whether the passing condition “(length of line segment EF)>w+α1” is satisfied. When command value calculator 123 has determined that the passing condition is not satisfied (No in Step S44), command value calculator 123 causes electric vehicle 10 to reverse (Step S46). To reverse, electric vehicle 10 moves a predetermined distance backward toward the entrance of narrow passage 20. The predetermined distance may be distance X3 or any other distance.

In contrast, when command value calculator 123 has determined that the passing condition is satisfied (Yes in Step S44), command value calculator 123 determines whether joystick 110 is tilted forward (that is, tilted toward the exit of narrow passage 20) and points E, F, and G are thereby present within detection range 2 (Step S45). When command value calculator 123 has determined that joystick 110 is not tilted forward (No in Step S45), or more specifically, that points E, F, and G are not present within detection range 2, command value calculator 123 executes Step S46. More specifically, at this time, by tilting joystick 110 in a direction different from the direction of the exit of narrow passage 20, occupant 1 declines to drive to the exit of narrow passage 20 and selects driving to the entrance of narrow passage 20.

In contrast, when command value calculator 123 has determined that joystick 110 is tilted forward (Yes in Step S45), or more specifically, that points E, F, and G are present within detection range 2, command value calculator 123 causes electric vehicle 10 to travel to lead point O, which is the rotation center of electric vehicle 10, toward point G (Step S47). Furthermore, command value calculator 123 determines whether point O has reached point G (Step S48). When command value calculator 123 has determined that point O has not reached point G (No in Step S48), command value calculator 123 repeats the processes from Step S47. In contrast, when command value calculator 123 has determined that point O has reached point G (Yes in Step S48), command value calculator 123 repeats the processes from Step S41.

As described thus far, by the control method used by control device 100 to control electric vehicle 10 according to the present embodiment, command value calculator 123 sets the traveling mode of electric vehicle 10 to the manual mode. In this manual mode, electric vehicle 10 travels in a direction and at a speed based on an operation performed on joystick 110 by occupant 1 of electric vehicle 10. Then, narrow passage determiner 122 determines whether narrow passage 20 having a width that satisfies a predetermined condition is present within detection range 2 that is set in the vicinity of electric vehicle 10 based on the operation. Note that the width that satisfies the predetermined condition is, for example, a width that satisfies a condition that this width is greater than the sum of width w and extra width α1 of electric vehicle 10. When narrow passage 20 has been determined to be present, command value calculator 123 switches the traveling mode of electric vehicle 10 from the manual mode to the narrow passage mode. In the narrow passage mode, electric vehicle 10 autonomously travels along narrow passage 20. Here, narrow passage 20 is an example of a passage, and the narrow passage mode is also referred to as a passage mode. Joystick 110 is an example of the operation component.

With this, when narrow passage 20 is present within detection range 2 set based on the operation performed by occupant 1, the traveling mode of electric vehicle 10 is switched from the manual mode to the narrow passage mode. More specifically, the operation to tilt joystick 110 toward narrow passage 20 that occupant 1 wants to pass through allows the entrance of narrow passage 20 to be within detection range 2. Thus, without precisely operating joystick 110, occupant 1 can drive electric vehicle 10 along narrow passage 20. Furthermore, when a plurality of narrow passages 20 are present in the vicinity of electric vehicle 10, occupant 1 can select narrow passage 20 that occupant 1 wants to pass through, using joystick 110. Thus, occupant 1 can easily drive electric vehicle 10 along narrow passage 20 as intended.

In the narrow passage mode according to the present embodiment, command value calculator 123 causes electric vehicle 10 to autonomously travel while occupant 1 continuously operates joystick 110, as illustrated in FIG. 6 to FIG. 12.

With this, although electric vehicle 10 is autonomously traveling, occupant 1 is operating joystick 110 and this makes occupant 1 feel as if manually driving electric vehicle 10. More specifically, the intention of occupant 1 can be reflected more in the autonomous driving of electric vehicle 10.

In the narrow passage mode according to the present embodiment, command value calculator 123 causes electric vehicle 10 to autonomously travel when direction b based on the operation performed on joystick 110 by occupant 1 is within a predetermined angular range from a reference direction. The predetermined angular range is detection range 2 within which points A and B are settable as in FIG. 4 to FIG. 8 or detection range 2 within which points E and F are settable as in FIG. 9 to FIG. 12. The predetermined angular range is from −30 degrees to +30 degrees, for example.

With this, even when a difference between the direction based on the operation performed on joystick 110, that is, direction b in which joystick 110 is tilted, and the reference direction is within the predetermined angular range, electric vehicle 10 can be driven along narrow passage 20. More specifically, electric vehicle 10 can be driven along narrow passage 20 without the need for a precise operation on joystick 110.

Furthermore, the aforementioned reference direction according to the present embodiment is one of: the direction of travel of electric vehicle 10; heading direction a of electric vehicle 10; or a direction along a center line of narrow passage 20. Note that the direction along the center line of narrow passage 20 is a direction of line segment CD or line segment GH described above.

For example, when the direction of travel or heading direction a is along the center line of narrow passage 20, occupant 1 fails to zero angle θ between heading direction a and direction b based on the operation performed on joystick 110 in some cases even if occupant 1 wants to. Even in such a case, electric vehicle 10 can be driven along narrow passage 20. Thus, regardless of operational skills of occupant 1, electric vehicle 10 can be driven smoothly along narrow passage 20.

Furthermore, in the narrow passage mode according to the present embodiment, command value calculator 123 calculates a position of at least one point disposed along narrow passage 20 and controls the direction of travel of electric vehicle 10 to cause electric vehicle 10 to pass through the at least one point. To be more specific, in the controlled direction of travel of electric vehicle 10, point O passes through the at least one point including point D or G disposed along narrow passage 20.

With this, the operation on joystick 110 by occupant 1 is performed to inform control device 100 only about the intention of occupant 1 to drive electric vehicle 10 along narrow passage 20. More specifically, the operation is not used for precisely controlling the direction of travel of electric vehicle 10. Thus, regardless of operational skills of occupant 1, electric vehicle 10 can be smoothly driven along narrow passage 20.

Furthermore, in the present embodiment, command value calculator 123 determines whether narrow passage 20 is outside detection range 2. When narrow passage 20 has been determined to be outside detection range 2, command value calculator 123 switches the traveling mode of electric vehicle 10 from the narrow passage mode to the manual mode. For example, when points E and F are not calculated, narrow passage 20 is determined to be outside detection range 2, as in FIG. 13.

With this, when narrow passage 20 has been determined to be outside detection range 2, this means that electric vehicle 10 is in the vicinity of the exit of narrow passage 20. The traveling mode switched to the manual mode at this time allows occupant 1 to drive electric vehicle 10 as intended without regard to narrow passage 20. Thus, the narrow passage mode is smoothly switched to the manual mode.

Furthermore, in the narrow passage mode according to the present embodiment, the autonomous driving of electric vehicle 10 is stopped when the operation performed on joystick 110 by occupant 1 is paused, and the autonomous driving of electric vehicle 10 is resumed when the operation is resumed.

With this, even when electric vehicle 10 is autonomously traveling, electric vehicle 10 can be stopped or driven as intended by occupant 1.

### OTHER EMBODIMENTS

Although control device 100 according to one or more aspects of the present disclosure has been described based on an embodiment, the present disclosure is not limited to this embodiment. Those skilled in the art will readily appreciate that embodiments arrived at by making various modifications to the above embodiment without materially departing from the scope of the present disclosure may be included within one or more aspects of the present disclosure.

For example, although joystick 110 is used as the operation component operated by occupant 1 in the embodiment described above, an operation component of a different type may be used. For example, an operation component having at least one button may be used.

In the embodiment described above, each of the elements included in control device 100 may be configured in the form of an exclusive hardware product, or may be realized by executing a software program suitable for the element. Each of the elements may be realized by means of a program executer, such as a CPU or a processor, reading and executing the software program recorded on a recording medium, such as a hard disk or a semiconductor memory. Here, the software program for realizing, for example, control device 100 according to the embodiment described above is a program for causing a computer to execute the steps of the flowcharts illustrated in FIG. 18 to FIG. 19C, for example.

It should be noted that the present disclosure may also include the following embodiments.

(1) Control device 100 described above may specifically be a computer system including, for example, a microprocessor, ROM (Read Only Memory), and RAM (Random Access Memory), a hard disk unit, a display unit, a keyboard, a mouse, and the like. The RAM or the hard disk unit holds a computer program. The microprocessor operates according to the computer program to cause each of the one or more devices described above to execute its function. Here, the computer program includes combinations of instruction codes for issuing instructions to the computer to execute predetermined functions.

(2) At least one of constituent elements included in the control device described above may be implemented into a single Large Scale Integration (LSI). The system LSI is a multi-functional LSI in which a plurality of elements are integrated into a single chip. An example of such a system LSI is a computer system including a microprocessor, a ROM, a Random Access Memory (RAM), and the like. The ROM stores a computer program. The microprocessor operates according to the computer program to cause the system LSI to execute its function.

(3) At least one of the constituent elements included in the control device described above may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to execute its functions. The IC card or the module may have tamper resistance.

(4) The present disclosure may be the above-described methods. These methods may be a computer program executed by a computer, or digital signals forming the computer program.

The present disclosure may be a computer-readable recording medium on which the computer program or the digital signals are recorded. Examples of the computer-readable recording medium are a flexible disk, a hard disk, a Compact Disc-Read Only Memory (CD-ROM), a Digital Versatile Disc (DVD), a DVD-ROM, a DVD-RAM, a BD (Blu-ray (registered trademark) Disc), and a semiconductor memory. The present disclosure may be the digital signals recorded on the recording medium.

The present disclosure may be implemented by transmitting the computer program or the digital signals via an electric communication line, a wired or wireless communication line, a network represented by the Internet, data broadcasting, and the like.

It is also possible that the program or the digital signals may be recorded onto the recording medium to be transferred, or may be transmitted via a network or the like, so that the program or the digital signals can be executed by a different independent computer system.

### INDUSTRIAL APPLICABILITY

The control device according to the present disclosure has the advantageous effect of easily causing an electric vehicle to travel along a narrow passage as intended by an occupant, and is applicable to a device or a system that controls an electric vehicle.

1. A control method to be performed by a computer to control an electric vehicle that includes an operation component, the control method comprising:
setting a traveling mode of the electric vehicle to a manual mode in which the electric vehicle travels in a direction and at a speed that are based on an operation performed on the operation component by an occupant of the electric vehicle;
determining whether a passage having a width that satisfies a predetermined condition is present within a detection range, the detection range being set in a vicinity of the electric vehicle and being based on the operation; and
when the passage is determined to be present, switching the traveling mode of the electric vehicle from the manual mode to a passage mode in which the electric vehicle autonomously travels along the passage.

2. The control method according to claim 1,
wherein in the passage mode,
the electric vehicle is set to autonomously travel while the occupant continuously operates the operation component.

3. The control method according to claim 1,
wherein in the passage mode,
the electric vehicle is set to autonomously travel when the direction based on the operation performed on the operation component by the occupant is within a predetermined angular range from a reference direction.

4. The control method according to claim 3,
wherein the reference direction is one of: a direction of travel of the electric vehicle; a heading direction of the electric vehicle; or a direction along a center line of the passage.

5. The control method according to claim 1, further comprising:
in the passage mode,
calculating a position of at least one point disposed along the passage; and
controlling a direction of travel of the electric vehicle to cause the electric vehicle to pass through the at least one point.

6. The control method according to claim 1, further comprising:
determining whether the passage is outside the detection range; and
when the passage is determined to be outside the detection range, switching the traveling mode of the electric vehicle from the passage mode to the manual mode.

7. The control method according to claim 1, wherein:
in the passage mode,
autonomous driving of the electric vehicle is stopped when the operation performed on the operation component by the occupant is paused, and
the autonomous driving of the electric vehicle is resumed when the operation is resumed.

8. A control device that controls an electric vehicle that includes an operation component, the control device comprising:
a sensor that detects a position of an object; and
a control processor that controls the electric vehicle based on an operation received by the operation component,
wherein the control processor:
sets a traveling mode of the electric vehicle to a manual mode in which the electric vehicle travels in a direction and at a speed that are based on an operation performed on the operation component by an occupant of the electric vehicle;
determines, based on a detection result of the sensor, whether a passage having a width that satisfies a predetermined condition is present within a detection range, the detection range being set in a vicinity of the electric vehicle and being based on the operation; and
when the passage is determined to be present, switches the traveling mode of the electric vehicle from the manual mode to a passage mode in which the electric vehicle autonomously travels along the passage.

9. An electric vehicle comprising:
the control device according to claim 8;
the operation component;
a motor that generates power for propelling the electric vehicle; and
a drive controller that drives the motor under control of the control device.

10. A non-transitory computer-readable recording medium having recorded thereon a computer program for controlling an electric vehicle that includes an operation component, the computer program causing a computer to execute:
setting a traveling mode of the electric vehicle to a manual mode in which the electric vehicle travels in a direction and at a speed that are based on an operation performed on the operation component by an occupant of the electric vehicle;
determining whether a passage having a width that satisfies a predetermined condition is present within a detection range, the detection range being set in a vicinity of the electric vehicle and being based on the operation; and
when the passage is determined to be present, switching the traveling mode of the electric vehicle from the manual mode to a passage mode in which the electric vehicle autonomously travels along the passage.
